(19) United States
(12) Patent Application Publication
(10) Pub. No.: US 2006/0096849 A1
(43) Pub. Date: May 11, 2006

(54) Method for separating butenes and butanes by extractive distillation provided with a polar extraction agent

(76) Inventors: Lothar Kerker, DULMEN (DE); Rainer Malzkorn, Dorsten (DE)

Correspondence Address: OBLON, SPIVAK, MCCLELLAND, MAIER & NEUSTADT, P.C., 1940 DUKE STREET, ALEXANDRIA, VA, 22314, US

(21) Appl. No.: 10/527,322

(22) PCT Filed: Aug. 6, 2003
(86) PCT No.: PCT/EP03/08687

§ 371 Date: Sep. 12, 2005

(30) Foreign Application Priority Data
Sep. 16, 2002 (DE) 102 42 923.5

(51) Int. Cl. B01D 3/34

(52) U.S. Cl. 203/53; 203/57; 203/59; 203/58; 203/60

(57) ABSTRACT

The invention relates to a process for separating butenes and butanes by extracting with a polar extractant.

The invention relates to a process for separating butenes and butanes from a stream comprising C₄-hydrocarbons by extractive distillation using a polar extractant. Butenes and butanes are products in high industrial demand and are usually obtained by working up cuts comprising C₄-hydrocarbons from steam or naphtha crackers. In the available raw material sources, the different isomers of the butenes and butanes and also butadiene are present in varying proportions. Butadiene may either be converted to n-butenes by hydrogenation or removed from these mixtures by extractive distillation. For further workup of the butenes and butanes, it is frequently necessary to separate them from each other. As a consequence of the very close proximity of their boiling points, this is not possible in the purities required by simple distillation, so that it is necessary to resort to other separating processes.

On the industrial scale, extractive distillations with polar solvents are usually used. For instance, EP 501 848 describes the separation of a C₄ cut freed of butadiene by extractive distillation with an extractant such as N-methylpyrrolidone (NMP) or DMF in 3 stages: in the first stage, the starting C₄-hydrocarbon mixture is admixed with the extractant in an extractive distillation column. This dissolves the olefinic constituents in the extractant, so that the less readily soluble aliphatic constituents may be removed. For further separation or for recovery of the extractant, a partial desorption of the butenes from the extract is then carried out under a pressure of from 4 to 5 bar. To recover the remainder of the extractant, the extract is subsequently boiled at a temperature of from 140° to 170° C. and atmospheric pressure.

JP 692 876 discloses the use of dimethylformamide as a polar extractant for butene/butane separation. This document also states that, after the extractive distillation and the removal of the aliphatic constituents from the starting hydrocarbon mixture, the majority of the polar extractant is recovered by a desorption stage at from 1 to 2 atmospheres while recycling the majority of the extractant. The butenic fraction is freed of the butenes in a purification stage at an elevated pressure of from 1 to 15 atmospheres; the pure extractant obtained in this way is recycled back into the extraction distillation stage. According to the examples, the extractant still contains large proportions of butenes which are recycled with the extractant, i.e. recirculated. This is energetically and economically unfavorable.

It has now been found that the energy utilization of the existing processes may be improved by an arrangement of the plant parts which has been optimized from a process technology point of view.

The present invention therefore provides a process for separating butenes and butanes by extractive distillation using a polar extractant by
a) extractively distilling a stream comprising butenes and butanes using a polar extractant to obtain a top fraction comprising butanes and a bottom fraction comprising butenes and the polar extractant and
b) destillatively separating the bottom fraction from a) into a low boiler fraction which comprises the butenes and a high boiler fraction which comprises the polar extractant, in which the high boiler fraction from b) comprising the polar extractants is recycled into the extraction stage a).

The butene fraction obtained in this way is freed sufficiently of polar extractant for many applications. For an improved separating performance, a portion of the low boiler fraction from stage b) may be recycled into the extraction stage a). In practice, a useful recycle ratio from stage b) to stage a) has proven to be 0.01-0.5 kg/kg, preferably 0.05- 0.2 kg/kg.

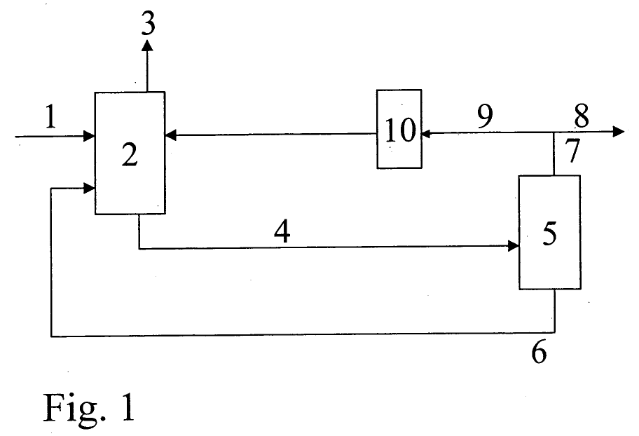

The recycle ratio is defined here as the ratio of the amount recycled to the amount of product. In FIG. 1, the recycle ratio corresponds to the quotient of streams 9 and 8.

Stage b) is generally performed at from 1.0 to 5 bar. When stage a) has a higher pressure level, the portion of the low boiler fraction recycled from b) into stage a) may be precompressed to the pressure of stage a). Such a process is outlined by FIG. 1: in this process, the butane/butene mixture (1) is separated in the extraction stage (2) into the butanes (3) and a fraction comprising the butenes and a polar extractant (4). Stream (4) is separated in the distillation stage (5) into a high boiler fraction (6) which comprises the polar extractant and possibly still butenes, and a low boiler fraction (7) which includes the butenes and possibly residues of extractant. Some or all of stream (7) is removed and optionally processed further (8) and/or recycled back into extraction stage (2) after an optional compression stage (10).

The compression stage (10) may also be arranged directly downstream of the distillation stage, so that the low boilers obtained from it may be completely condensed and subsequently divided in liquid form into product and recycle stream.

Instead of, or in addition to, a compression stage, the recycle stream may be cooled. This cooling stage should effect cooling of the stream to from −10 to +55° C., preferably 0-35° C.

In a special variant, the process according to the invention has a further separating stage c). In this stage, some or all of the low boiler fraction of stage b) is separated in a second separating stage c) into a butene-containing fraction and a fraction comprising the polar extractant, and the fraction comprising the polar extractant is recycled into the distillative separation of stage b).

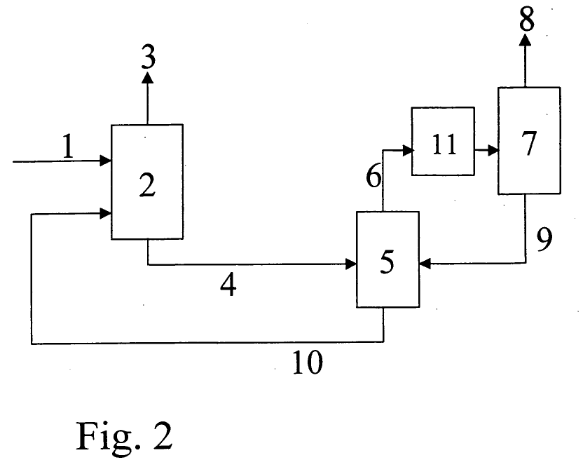

In the process according to the invention, importance attaches to the order of the pressure levels of pressure stages a), b) and optionally c). The distillative separation in stage b) is preferably carried out at a pressure of from 1 to 5 bar, in particular from 1 to 3 bar. In accordance with this pressure, the temperatures vary from 120- 190° C., in particular from 125-160° C. In this way, a large portion of the polar extractant is removed even at relatively low temperatures in a benign manner for the olefinic constituents. The second separation of stage c) of the process according to the invention is preferably carried out by distillation at a pressure of 1-10 bar, in particular 3- 7 bar. This process variant is illustrated in detail by FIG. 2 as follows.

The starting hydrocarbon mixture (1) is reacted in the extraction stage (2) with a polar extractant, so that the butanes (3) may be removed as a low boiler fraction. The butenes and the polar extractant as the bottom fraction (4) are fed to a distillative separation (5), and a mixture of butenes and the polar extractant is removed as the low boiler fraction (6). The low boiler fraction generally still comprises 1-6% by weight of extractant. When water is present, the solvent fraction of the low boiler fraction consists mainly of water, and in the case of the NMP/water system, approx. 1.5-3% of this fraction consists of water with approx. 100-1000 ppm of NMP. The stream (6) is subsequently worked up in a further separating stage (7) to give the pure butenes (8), and small polar amounts of the extractants and any water as the high boiler fraction (9) are recycled into the first separating stage (5). Depending on the purity requirements of the butenes (8) and the separating performance of the column (7), the stream (9) may still comprise butenes in addition to the polar extractant. The high boiler fraction (10) which was obtained in the first separating stage (5) and includes the majority of the polar extractant is recycled into extraction stage (2). In this process variant too, a compression and/or cooling stage (11) is advantageous.

In the second separating stage c), the temperatures vary from 40- 100° C. in accordance with the pressure set.

In a further process variant, the second process stage c) is not carried out by distillative separation, but rather by cooling the low boiler fraction from stage b) to from −10 to +55° C., preferably 0-55° C., in particular 0-35° C. The pressures necessary for this purpose vary from 1.0 to 5 bar, preferably from 1-3.0 bar. This variant may advantageously be used anywhere where inexpensive cooling energy is available. Also, there are none of the capital costs for pressure-resistant apparatus required in the other process variants.

This variant of the process according to the invention may likewise be illustrated with the aid of FIG. 2, although the second separating stage (7) is not designed as a distillative separation, but rather as a top condenser of the column (5). The butenes (8) are recycled (9) and removed in a similar manner. No compression and/or cooling stage (11) is needed in this variant.

In both process variants, the polar extractant used may be dimethylformamide (DMF), N-methylpyrrolidone, acetonitrile, furfural, N-formylmorpholine or dimethylacetamide. The extractants used may be used either anhydrously or virtually anhydrously or else in a mixture of from 0.1 to 20% by weight, preferably from 3 to 18% by weight, more preferably from 5 to 12% by weight, in particular from 8 to 9% by weight, with water.

The extraction distillation of stage a) is preferably performed at a temperature of from 40 to 100° C. and a pressure of from 2 to 15 bar. Customarily, such columns are operated in countercurrent, i.e. the extractant is introduced into the column from above and the stream to be extracted from below. Optionally, the C₄ stream may also be fed in the middle portion of the column. In the present case, the C₄ hydrocarbon stream to be extracted is preferably evaporated upstream of the column and contacted with the polar extractant as a gas stream in a mass ratio of 15:1-6:1, preferably 12:1-6:1 (gas:liquid). Advantageously, the column is equipped with internals or random packings to provide a very large exchange surface area. At the top of the column, the butene-containing mixture (n- and isobutane) is then removed in gaseous form and fed to a further use. The bottom of the column may be heated externally or internally, and some or all of the bottom fraction may be fed to a distillative separation in stage b). Useful internals for the extractive distillation column have proven to be in particular random packings, bubble-cap trays or valve trays.

In a preferred embodiment, the C₄ stream obtained at the top of the column (stream 3 in the figures) is completely condensed and partly recycled to back-wash the polar extractant. In this context, recycle ratios of from 0.5 to 2, in particular of 1:1, have proven useful.

The bottom fraction obtained from stage a) is subsequently decompressed and preferably conducted to the top of the distillation column of step b). This column is preferably filled with random packings and operated in countercurrent at a bottom temperature of from 120 to 160° C. The column bottoms are recycled into the extraction distillation of stage a). The low boiler fraction which is to be removed at the top and comprises the butenes and the small amounts of the polar extractant mentioned is cooled to a temperature of from 30 to 60° C. and then fed to purification stage c).

In the process variant of FIG. 2, the low boiler fraction of step b) initially passes through a compression stage and is compressed to the pressure levels mentioned. The purification stage (7) may also be operated as a countercurrent distillation plant in which the low boiler fraction from stage b) is introduced into the bottom of the column. The polar extractant accumulated in the bottom is not extracted into the extraction distillation of stage a), but exclusively into the purification stage b). A recycle ratio between the purification stages b) and c) of 0.001-0.1 kg/kg, preferably 0.01-0.1 kg/kg, has proven useful. The recycle ratio is defined here as the quotient of the amount recycled in stage b) to the amount introduced into purification stage c). In FIG. 2, this corresponds to the ratio of the streams 9:6. In this separating stage too, preference is given to recycling a portion of the top product into the column to improve the separating performance.

When the polar extractant used is a hydrous mixture, a further, small separating stage following the separating stage c) is recommended, by which the butenes are removed as bottom products and an aqueous phase is removed at the top of the column by means of a decanter and is recycled into separating stage b), optionally with premixing with the polar extractant.

In the alternative process variant of FIG. 2, the separating stage c) is performed without a compressor as a top condenser of stage b). To this end, it is necessary to completely condense the low boiler fraction of stage b) to a temperature of approx. 10-25° C. A portion of the liquid fraction is recycled back into the column b) in countercurrent.

### Example:

The extractive distillation (2) of the butane/butene mixture (1), and also the removal of the butenes (7) from the solvent (6) was carried out using a plant according to FIG. 1. The solvent used was an NMP/H₂O mixture comprising about 80% by weight of water. The extractive distillation column (2) had a diameter of 80 mm and was equipped with 70 bubble-cap trays. The outgassing column (5) likewise had a diameter of 80 mm and was equipped with 30 bubble-cap trays. The butane product stream (3) was completely condensed and partly recycled into the column (2) at a recycle ratio of 1 kg/kg. The butene product stream (7) obtained was cooled to 50° C. and was completely in gaseous form, i.e. there was no butene recycling (9) to the extractive distillation column (2). The liquid stream occurring on cooling to 50° C. was conducted back into the column (5).

The operating parameters of the two columns were as follows:

| | | Column | Column |
|---|---|---|---|
| | | (2) | (5) |
| Pressure | bar | 5.0 | 1.8 |
| Temperature | | | |
| Top | ° C. | 47 | 50 |
| Bottom | ° C. | 102 | 148 |
| Feed tray | | | |
| Butanes butenes | — | 31 | — |
| Solvent | — | 60 | 30 |
| Recycle ratio | kg/kg | 1.00 | 0.07 |
| Outputs | | | |
| Condenser | W | 400 | 100 |
| Evaporator | W | 1200 | 1100 |

The amounts and the compositions of the streams are reported in the following table:

| | | | | Column (2) | | Column (5) | |
|---|---|---|---|---|---|---|---|
| | | Feed | | Top | Bottom | Top | Bottom |
| | | Butanes/ | Feed | product | product | product | product |
| | | butenes | NMP/H2O | Butanes | NMP/H2O | Butenes | NMP/H2O |
| | | (1) | (6) | (3) | (4) | (8) | (6) |
| Temperature | [° C.] | 50.7 | 50.0 | 47.2 | 101.7 | 50.0 | 147.9 |
| Mass stream | [kg/h] | 3.00 | 30.00 | 1.89 | 31.11 | 1.14 | 29.97 |
| Mass fractions | | | | | | | |
| n-Butane | [kg/kg] | 0.620 | 0.000 | 0.900 | 0.005 | 0.139 | 0.000 |
| 1-Butene | [kg/kg] | 0.010 | 0.000 | 0.010 | 0.000 | 0.009 | 0.000 |
| cis-2-Buten | [kg/kg] | 0.120 | 0.000 | 0.017 | 0.011 | 0.287 | 0.000 |
| trans-2-Butene | [kg/kg] | 0.250 | 0.000 | 0.069 | 0.020 | 0.544 | 0.000 |
| Water | [kg/kg] | 0.000 | 0.083 | 0.004 | 0.080 | 0.021 | 0.082 |
| NMP | [kg/kg] | 0.000 | 0.917 | 0.000 | 0.884 | 0.000 | 0.918 |

This plant arrangement allowed a butane stream having 90% purity and a butene stream having 84% purity to be obtained.

In the claims:

1-11. (canceled)

12. A process for separating butenes and butanes by extractive distillation using a polar extractant by
a) extractively distilling a stream comprising butenes and butanes using a polar extractant to obtain a top fraction comprising butanes and a bottom fraction comprising butenes and the polar extractant and
b) destillatively separating the bottom fraction from a) into a lower boiler fraction which comprises the butenes and a high boiler fraction which comprises the polar extractant, being recycled the high boiler fraction from b) comprising the polar extractants, into the extraction stage a),
wherein, some or all of the low boiler fraction of stage b) is separated in a second separating stage c) into a butene-containing fraction and a fraction comprising the polar extractant, and the fraction comprising the polar extractant is recycled into the distillative separation of stage b).

13. The process as claimed in claim 12, wherein the distillative separation of stage b) is carried out at a pressure of from 0.5 to 5 bar.

14. The process as claimed in claim 12, wherein a portion of the low boiler fraction of stage b) is recycled into the extraction stage a).

15. The process as claimed in claim 14, wherein the recycle ratio of stage b) to stage a) is 0.01-0.5 kg/kg.

16. The process as claimed in claim 14, wherein the portion of the low boiler fraction b) recycled into stage a) is compressed to the working pressure of stage a).

17. The process as claimed in claim 12, wherein the recycle ratio of stage c) to stage b) is 0.001-0.1 kg/kg.

18. The process as claimed in claim 12, wherein the second separating stage c) is effected by distillation at a pressure of 1-5 bar.

19. The process as claimed in claim 12, wherein the second separating stage c) is effected by cooling the low boiler fraction from stage b) to from −10 to +55° C.

20. The process as claimed in claim 12, wherein the polar extractant is used anhydrously or in a mixture with from 0.1 to 20% by weight of water.

21. The process as claimed in claim 12, wherein the polar extractant used is dimethylformamide, N-methylpyrrolidone, acetonitrile, furfural, N-formylmorpholine or dimethylacetamide.
